(19) United States
(12) Patent Application Publication
(10) Pub. No.: US 2011/0215492 A1
(43) Pub. Date: Sep. 8, 2011

(54) MANUFACTURING METHOD OF ASPHERIC SURFACE LENS

(76) Inventors: Toshiya Tomisaka, Osaka (JP); Koichi Wakita, Osaka (JP)

(21) Appl. No.: 13/128,808

(22) PCT Filed: Nov. 13, 2009
(86) PCT No.: PCT/JP2009/069362

§ 371 Date: May 11, 2011

(30) Foreign Application Priority Data
Nov. 19, 2008 (JP) 2008295434

(51) Int. Cl. B29D 11/00

(52) U.S. Cl. 264/1.21

(57) ABSTRACT

Provided is an aspheric lens manufacturing method by which an aspheric lens having a desired shape can be manufactured with high accuracy regardless of the shape of a glass molding without reducing productivity. The aspheric lens manufacturing method for forming the aspheric lens by pressing and machining a glass material includes a pressing step for pressing the glass material to thereby form the aspheric surface, the flat surface of the peripheral portion of the aspheric surface, and the side surface continuous to the flat surface at the same time and form the glass molding, a mounting step for mounting the glass molding in a work holder which holds and positions the glass molding by being in contact with the flat surface and the side surface of the glass molding formed in the pressing step, and a machining step for machining an other surface of the glass molding mounted in the work holder in the mounting step to thereby form the other surface into a predetermined surface shape.

### TECHNICAL FIELD

The present invention relates to a manufacturing method of an aspheric surface lens, and in particular to the manufacturing method of the spherical surface lens using a pressing process and a machining process.

### BACKGROUND

In recent years, the aspheric surface lenses became used as lenses for a digital camera, a pick up lens for a DVD and so forth, a lens for a mobile phone camera, a coupling lens for optical communication and various kinds of mirrors, while the application of the lens covers a widespread area. As the manufacturing method of the aspheric lens thereof, a pressing process, a machining process (collective term of a cutting process, grinding process and polishing process) are known.

The pressing process is a process to press a glass material softened by heat via an upper mold and a lower mold. In the above pressing process, though one surface of the lens can be formed in a short time, forming conditions were very severer and forming of both surfaces was difficult.

On the other hand, the machining process enables highly accurate forming, however since the polishing process requires a long time using an expensive and accurate special machine, there was a shortcoming that a longer working hours is required than the pressing process. Therefore, to address the above problems, there is suggested an aspheric lens manufacturing method employing advantages of each of the pressing process conventionally used and the highly accurate machining process in the Patent Document 1: Unexamined Japanese Patent Application Publication No. H06-206156.

In the method in Patent Document 1, firstly, by pressing the glass material, a glass molding, having a convex aspheric surface on one side and a flat surface on the other side, namely a substantially convex and flat glass molding, is molded. Next, the glass molding is inserted into a special centering holder, then the flat surface of the glass molding is formed into a concave spherical surface via a machining process, whereby a meniscus lens is formed.

### PRIOR ART DOCUMENT

### Patent Document

Patent Document 1: Unexamined Japanese Patent Application Publication No. H06-206156.

### SUMMARY OF THE INVENTION

### Problems to be Solved by the Invention

However, there is a problem that the method disclosed in Patent Document 1 can only be applied to the manufacturing method of the meniscus lens which is manufactured by forming the concave surface through machining the other surface of the glass molding on an assumption that the glass molding preliminarily formed by the pressing process is a glass molding having the convex aspheric surface on one side and the flat surface on the other side, namely a substantially flat-and-convex-shaped lens.

Also, an optical axis of the spherical surface and a center section of the centering holder are matched by fixing the optical axis of the spherical surface by contacting a less axis fixing section with a periphery section of the aspheric surface of the glass molding while the other flat surface of the glass molding is overlapped with a lens fixer. Therefore, a relative positional relation such as parallelism of the flat surface with respect to the aspheric surface of the glass molding has to be ensured with a high degree of accuracy, otherwise there is a problem that the axis of the spherical surface and that of the aspheric surface displace which causes decentering when the spherical surface is machined.

The present invention has one aspect to solve the above problems and an object of the present invention is to provide the aspheric surface lens manufacturing method capable of manufacturing the aspheric lens of a desired shape with a high degree of accuracy without reducing productivity regardless of the shape of the glass molding.

### Means to Solve the Problem

The above object can be achieved by any one of the following items.

Item 1. An aspheric lens manufacturing method to manufacture an aspheric lens by pressing and machining a glass material, having steps of: pressing the glass material to simultaneously form an aspheric surface, a flat surface of a peripheral portion of the aspheric surface, and a side surface continuous with the flat surface so as to obtain a glass molding, mounting the glass molding on a work holder which holds and positions the glass molding by being in contact with the flat surface and the side surface of the glass molding formed in the pressing step, and machining an other surface of the glass molding mounted on the work holder in the mounting step to form the other surface into a predetermined surface shape.

Item 2. The aspheric lens manufacturing method of item 1, wherein a mold to be used has an upper mold, a lower mold and a side surface mold to form the side surface.

Item 3 The aspheric lens manufacturing method of item 2, wherein after storing melt glass on the lower mold, the melt glass on the lower mold is pressed by the upper mold and the side surface mold.

Item 4. The aspheric lens manufacturing method of item 3, wherein a temperature of the melt glass supplied to the lower mold is higher than that of the lower mold.

Item 5. The aspheric lens manufacturing method of any one of items 2 to 4, wherein the side surface mold is fixed onto the upper mold or the lower mold.

Item 6. The aspheric lens manufacturing method of any one of items 1 to 5, wherein the work holder has a glass molding retaining member A to contact with the flat surface of the glass molding and a glass molding retaining member B to contact with the side surface of the glass molding.

Item 7. The aspheric lens manufacturing method of any one of items 1 to 6, wherein the flat surface is perpendicular to an optical axis of the aspheric surface and the side surface is parallel to the optical axis of the aspheric surface.

Item 8. The aspheric lens manufacturing method of any one of items 1 to 7, wherein the machining includes at least one of cutting, grinding and polishing.

### Effect of the Invention

According to the present invention, when the glass material is press-molded, since the aspheric surface, the flat surface at the peripheral portion of the aspheric surface and the side surface are formed at the same time, the relative positional relation among the aspheric surface, the flat surface and the side surface can be ensured. In other words, the relative positional relation of the optical axis of the aspheric surface with respect to the flat surface and the side surface can be ensured. Further, since the glass molding is retained by contacting the work holder with the flat surface and the side surface, of which relative positional relations with respect to the optical axis of the aspheric surface are ensured as above, inclination and decentering of the optical axis of the aspheric surface of the glass molding with respect to the center of the work holder is restricted, and the optical axis of the aspheric surface matches with the center of the work holder i.e. a work center. Thereby, when the other surface of the glass molding is formed into, for example, a spherical surface via machining, the optical axis of the spherical surface can be readily matched with the optical axis of the aspheric surface.

Since the flat surface and the side surface of the glass molding formed by the pressing process is supported, the other surface of the glass molding to be formed is not limited to the flat surface as in the conventional way and can be a convex or concave surface. For the same reason, the shape of the aspheric surface can be convex or concave.

Whereby, the aspheric lens of a desired shape can be manufactured without being limited to the shape of the glass molding.

### BRIEF DESCRIPTION OF THE DRAWINGS

FIG. 1 is a schematic cross-sectional view showing an outline configuration of a mold related to an embodiment of the present invention.

FIG. 2 is a schematic cross-sectional view showing a glass molding related to an embodiment of the present invention.

FIG. 3 is a schematic cross-sectional view showing an outline configuration of a work holder related to an embodiment of the present invention.

FIG. 4 is a schematic cross-sectional view showing a state where a glass molding is installed on a work holder related to an embodiment of the present invention.

FIG. 5 is a schematic cross-sectional view showing an exemplary molding apparatus related to an embodiment of the present invention.

### DESCRIPTION OF THE PREFERRED EMBODIMENTS

An embodiment of the aspheric surface lens manufacturing method related to the present will be described with reference to the drawings. Incidentally, the present invention will be described with reference to the embodiments shown by the drawings without the present invention being limited to the embodiments thereof.

In the aspheric surface lens manufacturing method related to the embodiments of the present invention, the glass material is pressed preliminarily so as to form a glass molding by forming a aspheric surface, a flat surface of a peripheral portion of the aspheric surface, and a side surface continuous with the flat surface thereof at the same time (pressing process). Next the glass molding is installed on a work holder to hold the glass molding, by contacting the work holder with the flat surface and the side surface of the glass molding formed via the pressing process. After that, another surface of the glass molding formed by the pressing process is formed into an aspheric surface by a machining process and the aspheric surface lens is manufactured (machining process). The details thereof will be described blow.

### (Pressing Process)

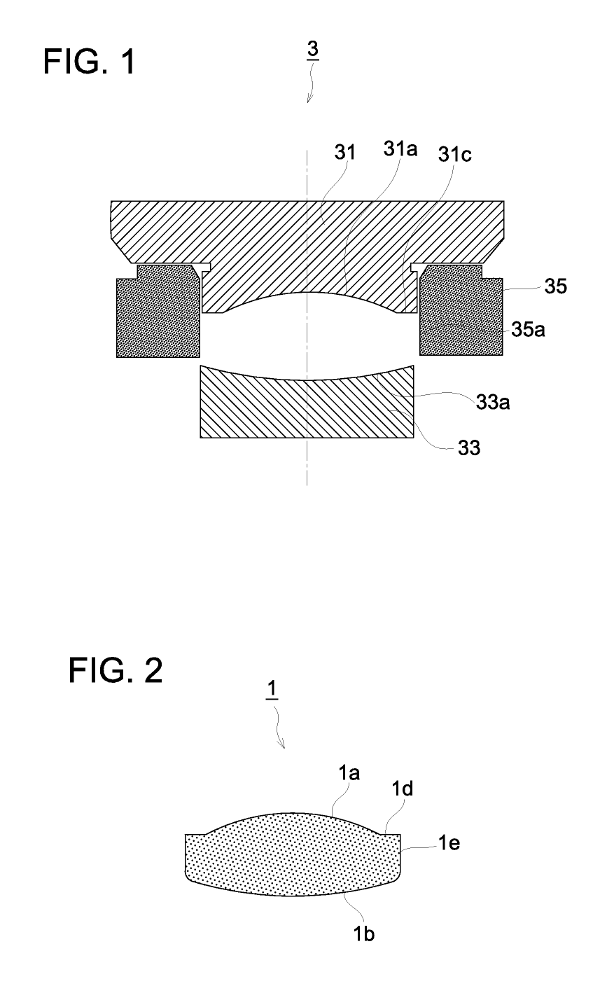

First, a configuration of the mold used in the pressing process will be described with reference to FIG. 1. FIG. 1 is a schematic cross-sectional view showing an outline configuration of a mold 3 related to an example of the present invention.

The mold 3 is configured with an upper mold 31, a lower mold 33 and a side surface mold 35.

On the upper mold 31, a molding surface 31a of an aspheric surface shape and a molding surface 31c of a flat surface shape at a peripheral portion of the molding surface 31a are formed. The molding surface 31c is a flat surface perpendicular to an optical axis of the aspheric surface formed by the molding surface 31a. In the lower mold 33 and the side surface mold 35, a molding surface 33a having concave surface shapes and the molding surface 35a are formed respectively. The molding surface 35a of the side surface mold 35 is a cylindrical surface which is coaxial with the axis of the aspheric surface formed by the molding surface 31a. Also the side surface mold 35 having a ring shape is inserted and fixed in the upper mold 31. Incidentally, in the present embodiment, while the molding surface 31a of the upper mold 31 is formed into a concave aspheric surface and the molding surface 33a of the lower mold 33 is formed into a concave surface, the both surface shapes are not limited to the above surface shapes and they can be convex surfaces. Also, in the present embodiment, while the molding surface of the aspheric surface and the molding surface of the flat surface at the peripheral portion of the aspheric surface are formed on the upper mold 31 and the molding surface of the concave surface is formed on the lower molding 33, the molding surface of the aspheric surface and the molding surface of the flat surface at the peripheral portion of the aspheric surface can be formed on the lower mold 33 and the molding surface of the concave surface can be formed on the upper molding 31 in an opposite manner, and the side surface mold 35 can be inserted and fixed in the lower mold 33.

A material of the upper mold 31, the lower mold 33 and the side surface mold 35 can be selected from materials known as the materials of the mold for pressure molding of a glass-made optical element such as an ultrahard material containing tungsten carbide, carbonized nitride, silicone nitride, silicone aluminum and carbon. Also, the above materials, having surfaces on which protection films such as various kinds of metal, ceramic and carbon are formed, can be used. The upper mold 31, the lower mold 33 and the side surface mold 35 can be formed with the same material or the different materials.

As a pressing process, a direct press method to mold a molten glass directly by pressure with the mold and publicly known methods can be used. The pressure devices are not particularly limited. Publicly know pressure devices such as an air cylinder, a hydraulic cylinder and an electric cylinder using a servo motor can be arbitrarily selected. The pressure device can drive either the upper mold 31 or the lower mold 33 or can drive both.

The glass materials are not particularly limited and can be arbitrarily selected from publicly known glass materials used in optical applications in accordance with use. For example, phosphoric acid system glass, and lanthanum system glass are cited.

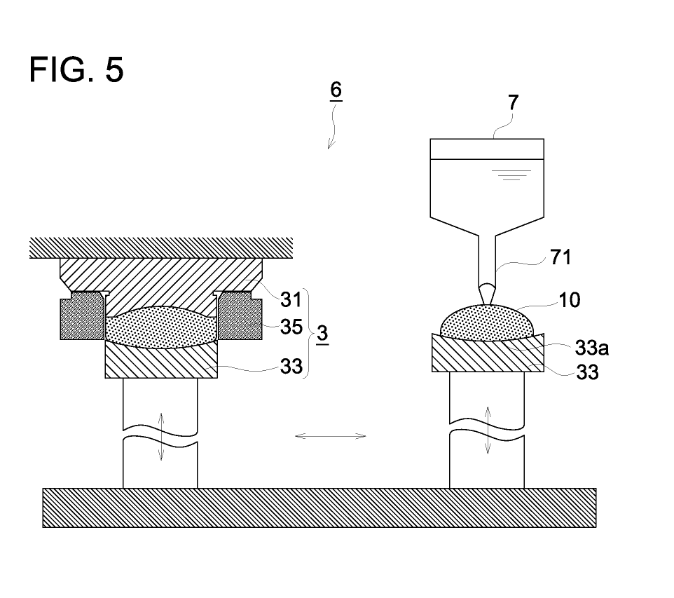

An outline of a molding method of the glass molding will be described with reference to FIG. 5. FIG. 5 is a schematic cross-sectional view showing an exemplary molding apparatus representing a manufacturing apparatus of the glass molding related to the embodiment of the present invention.

In the present embodiment, a melt glass 10 is supplied through a nozzle 71 disposed at a lower section of a melted vessel 7 to a receiving surface (molding surface 33a) of the lower mold 33 of the mold 3 heated at a predetermined temperature, which is lower than that of the molten glass. When this occurs, the melting vessel 7 and the nozzle 71 are heated by unillustrated heaters respectively at a predetermined temperature. The lower mold 33 retaining the molten glass 10 moves to the lower position of the upper mold 31, then the lower mold 33, upper mold 32 and the side surface mold 35 press-mold the melted glass 10, thus the glass molding to which each molding surface is transferred is obtained.

Incidentally, in the above molding method, during the molding process, cooling speeds of the melted glass differ between an upper surface and a lower surface or between a center section and an edge section of the molten glass 10, thus amounts of contraction due to cooling becomes uneven. In the lower mold 33 in particular, after the molten glass 10 lands at the center of the receiving surface (molding surface 33a), the molten glass gradually spreads to the periphery of the receiving surface as the molten glass is supplied, thus the contraction amount on the lower surface side of the molten glass 10 tends to be uneven. Therefore, it is difficult to mold the lower side of the melted glass with a high accuracy. On the other hand, at an upper surface side of the molten glass 10, cooling action by the lower mold 33 is weak and the upper surface side contacts with the upper mold 31 and the side surface mold 35 substantially at the same time. Thus, temperature of the upper surface side of the melted glass is relatively stable and the optical surface on the upper surface side can be molded with a high degree of accuracy. Therefore, in the present invention, the lower surface side of the glass molding formed by the press molding is machined at a post-process with a high degree of accuracy.

In FIG. 2, an exemplary glass molding formed by using a forming apparatus 6 having the above configuration is shown. FIG. 2 is a schematic cross-sectional view showing an exemplary glass molding 1.

As FIG. 2 shows, on one surface of the glass molding 1, an aspheric transfer surface 1a by the upper mold 31 and a flat transfer surface 1d at the peripheral portion of the transfer surface 1a are formed, also on the other surface, a convex transfer surface 1b by the lower mold 33 and further on the side surface, a cylindrical transfer surface 1e by the side surface mold 35 are respectively formed. Incidentally, the transfer surface 1e of the side surface can be formed on an entire side surface of the glass molding 1 or can be formed only on a part of the side surface. Also, in the following description, the transfer surface 1a, transfer surface 1d, the transfer surface 1b and the transfer surface 1e are also referred as an aspheric surface 1a, a periphery flat surface 1d, a convex surface 1b and a side cylindrical surface 1e respectively.

Here, the aspheric surface 1a representing one surface and the periphery flat surface 1d are formed by the upper mold 31, and the side cylindrical surface 1e is formed by the side surface mold 35 fixed at the upper mold 31 at the same time. Therefore, the relative positional relation among the aspheric surface 1a, the periphery flat surface 1d and the side cylindrical surface 1e is ensured. Namely, the relative positional relation among the optical axis of the aspheric surface 1a, the periphery flat surface 1d and the side cylindrical surface 1e is ensured.

### (Mounting Process)

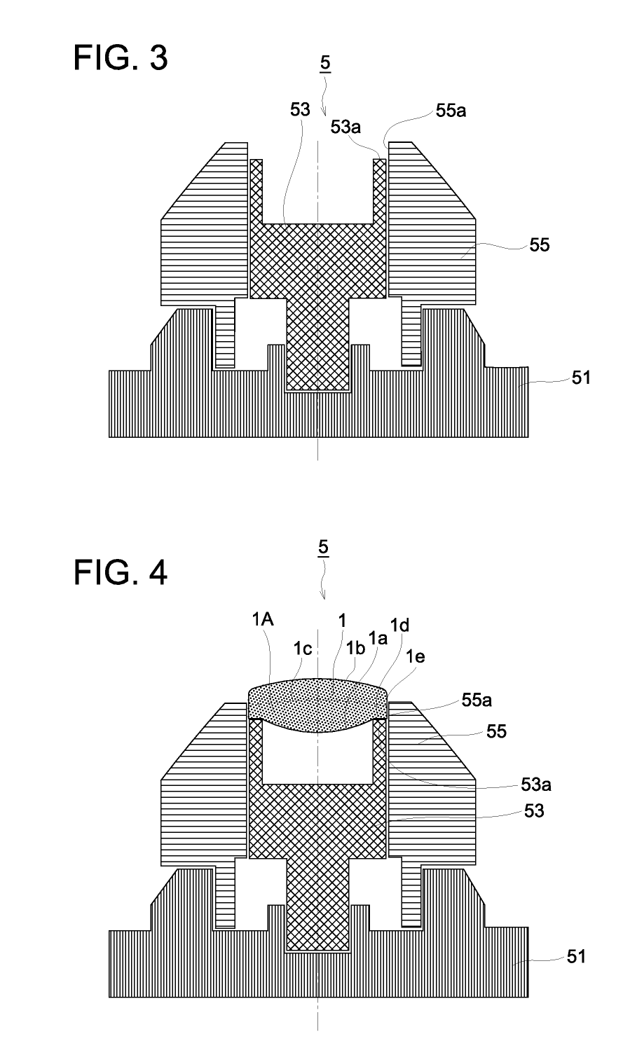

First, a configuration of a work holder to hold the glass molding 1 molded produced by the pressing process will be described with reference to FIG. 3. FIG. 3 is a schematic cross-sectional view showing an outline configuration of an exemplary work holder 5 related to the embodiment of the present invention.

As FIG. 3 shows a relevant portion of the work holder 5 is configured with a chuck 51, a work adaptor A53, the work adaptor B55 and so forth.

The chuck 51 holds the glass molding 1 (work) with a high degree of accuracy via the work adaptor 53 and the work adaptor 55 disposed at the chuck 51. As the chuck 51, a publicly known chuck, for example, a diaphragm chuck and so forth can be used.

The work adaptor 53 is equivalent to the glass molding retaining member A of the present invention, and on an upper surface thereof, there is formed a flat retaining surface 53a to contact with the periphery flat surface 1d of the glass molding 1 being mounted so as to retain the glass molding. By contacting the retaining surface 53a with the periphery flat surface 1d of which relative positional relation with respect to the optical axis of the aspheric surface 1a is ensured, inclination of the optical axis of the aspheric surface 1a with respect to the axis of the work holder can be restricted.

The work adaptor 55 is equivalent to the glass molding retaining member B of the present invention and in an upper part of an inner surface thereof, there is formed a retaining surface 55a having a cylindrical shape to retain the glass molding 1 by contacting with the side cylindrical surface 1e of the glass molding 1. By contacting the retaining surface 55a with the side cylindrical surface 1e of which relative positional relation with respect to the optical axis of the aspheric surface 1a is ensured, displacement of a center of the aspheric surface 1a with respect to the center of the work holder 5 is restricted.

FIG. 4 is a schematic cross-sectional view showing a state where the glass molding 1 is mounted on the work holder 5. As described in the foregoing, since the glass molding 1 is retained by contacting the periphery flat surface 1d and the side cylindrical surface 1e, of which relative positional relations with respect to the optical axis of the aspheric surface 1a of the glass molding 1 are ensured, with the retaining surface 53a and the retaining surface 55a respectively, inclination and displacement of the center of the optical axis of the aspheric surface 1a of the glass molding 1 with respect to the work holder 5 is restricted. Whereby, as FIG. 4 shows, the optical axis of the aspheric surface 1a coincides with the center of the work holder 5, i.e. the work center.

### (Machining Process)

In a state shown by FIG. 4, where the glass molding 1 is mounted on the work holder 5, the convex surface 1b representing other surface of the glass molding is machined, and formed into a convex surface (machined surface 1c) as the broken lines show so as to obtained an aspheric surface lens 1A. Incidentally, in the present embodiment, while the machined surface 1c is formed into the convex surface, the surface is not limited to the convex surface and it can be a concave surface.

As the machining process, publicly known processes such as a cutting process, a grinding process and a polishing process can be used.

Here, as described in the foregoing, the optical axis of the aspheric surface 1a of the glass molding 1 matches with the center of the work holder 5, i.e. the work center. Thus, by machining the convex surface 1b of the glass molding 1 in the above condition, the optical axis of the convex surface (machined surface 1c) can be matched with the optical axis of the aspheric surface 1a readily.

As above, in the manufacturing method of the aspheric lens 1A related to the embodiment of the present invention, when the pressing process is applied to the glass material, since the aspheric surface 1a on one surface, the periphery flat surface 1d and the side cylindrical surface 1e are formed at the same time, the relative positional relation among the aspheric surface 1a, the periphery flat surface 1d and the side cylindrical surface 1e can be ensured. In other words, the relative positional relation of the optical axis of the aspheric surface 1a with respect to the periphery flat surface 1d and the side cylindrical surface 1e can be ensured. Further, since the glass molding 1 is retained by contacting the retaining surface 53a and the retaining surface 55a with the periphery flat surface 1d and the side cylindrical surface 1e of which relative positional relation with respect to the optical axis of the aspheric surface 1a are ensured as above, inclination and decentering of axis of the aspheric surface 1a of the glass molding 1 with respect to the center of the work holder 5 is restricted, and the optical axis of the aspheric surface 1a matches with the center of the work holder 5, i.e. the work center. Thereby, when the other surface of the glass molding 1 is formed into, for example, a spherical surface via machining, the optical axis of the spherical surface can be readily matched with the optical axis of the aspheric surface.

Also, since the work holder is configured to retain the periphery flat surface 1d and the side cylindrical surface 1e of the glass molding 1 formed in the pressing process, the surface shape of the other surface of the glass molding 1 to be formed is not limited to a flat surface as in the conventional method and can be a concave and a convex surfaces. Also, for the same reason, the shape of the aspheric surface 1a can be a convex surface and a concave surface. Thereby, a desired shape of the aspheric surface lens can be formed without being restricted by the shape of the glass molding.

As the result, the aspheric surface lens in the desired shape can be manufactured with a high degree of accuracy irrespective of the shape of the glass molding without reducing productivity.

Incidentally, in the above description, while the example of the aspheric surface lens having the aspheric surface on one optical function surface has been described, the present invention can be applied to an aspheric surface lens having the aspheric surfaces on both optical functional surfaces.

### DESCRIPTION OF SYMBOLS

1 Glass molding
1A Aspheric surface lens
1a Transfer surface (aspheric surface)
1b Transfer surface (convex surface)
1d Transfer surface (peripheral portion flat surface)
1e Transfer surface (side cylindrical surface)
1c Machined surface
3 Mold
31 Upper mold
31a, 31c Molding surface
33 Lower mold
33a Molding surface
35 Side surface mold
35a Molding surface
5 Work holder
51 Chuck
53 Work adaptor A
53a Retaining surface A
55 Work adaptor B
55a Retaining surface B
6 Molding Apparatus
7 Melting vessel
71 Nozzle
10 Molten glass

1. A method of manufacturing an aspheric lens comprising:
pressing a glass material to simultaneously form an aspheric surface, a flat surface of a peripheral portion of the aspheric surface, and a side surface continuous with the flat surface so as to obtain a glass molding,
mounting the glass molding on a work holder which holds and positions the glass molding by being in contact with the flat surface and the side surface of the glass molding formed in the pressing step, and
machining an other surface of the glass molding mounted on the work holder in the mounting step to form the other surface into a predetermined surface shape.

2. The method of claim 1, wherein a mold to be used has an upper mold, a lower mold and a side surface mold to form the side surface.

3. The method of claim 2, wherein after storing melt glass on the lower mold, the melt glass on the lower mold is pressed by the upper mold and the side surface mold.

4. The method of claim 3, wherein a temperature of the melt glass supplied to the lower mold is higher than that of the lower mold.

5. The method of claim 1, wherein the side surface mold is fixed onto the upper mold or the lower mold.

6. The method of claim 1, wherein the work holder has a glass molding retaining member A to contact with the flat surface of the glass molding and a glass molding retaining member B to contact with the side surface of the glass molding.

7. The method of claim 1, wherein the flat surface is perpendicular to an optical axis of the aspheric surface and the side surface is parallel to the optical axis of the aspheric surface.

8. The method of claim 1, wherein the machining includes at least one of cutting, grinding and polishing.
